(19) United States
(12) Patent Application Publication
(10) Pub. No.: US 2024/0223280 A1
(43) Pub. Date: Jul. 4, 2024

(54) FREE-SPACE OPTICAL COMMUNICATION APPARATUS, FREE-SPACE OPTICAL COMMUNICATION SYSTEM, AND METHOD FOR CONTROLLING FREE-SPACE OPTICAL COMMUNICATION APPARATUS

(71) Applicant: NEC Corporation, Tokyo (JP)

(72) Inventor: Yohei Hasegawa, Tokyo (JP)

(73) Assignee: NEC Corporation, Tokyo (JP)

(21) Appl. No.: 18/390,143

(22) Filed: Dec. 20, 2023

(30) Foreign Application Priority Data
Dec. 28, 2022 (JP) 2022-212500

(51) Int. Cl. H04B 10/116; H04B 10/112

(52) U.S. Cl. CPC H04B 10/116; H04B 10/1125

(57) ABSTRACT

In a free-space optical communication apparatus, a light emission unit includes an emission direction control section which controls an emission direction of a laser beam outputted from a light source, and at least one processor carries out a communication control process of controlling the light emission unit to construct a plurality of free-space optical communication links each of which is constructed with use of the laser beam.

### CROSS REFERENCE TO RELATED APPLICATIONS

This application is based upon and claims the benefit of priority from Japanese Patent Application No. 2022-212500 filed on Dec. 28, 2022, the disclosure of which is incorporated herein in its entirety by reference.

### TECHNICAL FIELD

The present invention relates to a free-space optical communication apparatus, a free-space optical communication system, and a method for controlling the free-space optical communication apparatus.

### BACKGROUND ART

Recent years have witnessed a remarkable increase in traffic on the Internet, mobile networks, and the like, with an annual increase rate of 20% to 40%. This has led to growing expectations for practical application of networking using free-space optical communications (FSOC) which can drastically improve wireless communication speeds.

Free-space optical communication is a high-speed wireless communication performed via free space with use of light waves having wavelengths ranging from those of visible light to those of infrared light. In recent years, free-space optical communication has achieved communication speeds almost comparable to those of fiber communication. Further, in free-space optical communication, interception by a third party can be made difficult by using thin beams.

For example, Patent Literature 1 discloses an example of a technique for realizing free-space optical communication.

### CITATION LIST

### Patent Literature

### Patent Literature 1

Japanese Patent Application Publication, Tokukai, No. 2011-061267

### SUMMARY OF INVENTION

### Technical Problem

However, in free-space optical communication, in a case of constructing a plurality of links (connections) in order to achieve high reliability, transmission mechanisms and reception mechanisms (such as optical transceivers) are each required as many as the number of links. This undesirably increases the physical size of the apparatus.

An example aspect of the present invention has been made in view of the above problems, and an example object thereof is to provide a technique capable of constructing a plurality of free-space optical communication links with a compact configuration.

### Solution to Problem

A free-space optical communication apparatus in accordance with an example aspect of the present invention includes: a light emission unit; and at least one processor, the light emission unit including (i) a light source that outputs a single laser beam and (ii) an emission direction control section that controls an emission direction in which a laser beam is emitted from the light emission unit after being outputted from the light source in the form of the single laser beam, the at least one processor carrying out a communication control process of controlling the light emission unit to construct a plurality of free-space optical communication links with use of the laser beam.

A free-space optical communication system in accordance with an example aspect of the present invention includes not less than three of the free-space optical communication apparatus described above.

A method for controlling a free-space optical communication apparatus in accordance with an example aspect of the present invention is a method for controlling a free-space optical communication apparatus including a light emission unit, the light emission unit including: a light source that outputs a single laser beam; and an emission direction control section that controls an emission direction in which a laser beam is emitted from the light emission unit after being outputted from the light source in the form of the single laser beam, the method including a communication control process of controlling the light emission unit to construct a plurality of free-space optical communication links with use of the laser beam, the communication control process being carried out by at least one processor included in the free-space optical communication apparatus.

### Advantageous Effects of Invention

An example aspect of the present invention makes it possible to construct a plurality of free-space optical communication links with a compact configuration.

### BRIEF DESCRIPTION OF DRAWINGS

FIG. 1 is a block diagram illustrating an example of a schematic configuration of a free-space optical communication apparatus in accordance with a first example embodiment of the present invention.

FIG. 2 is a flowchart illustrating an example of a communication control process carried out by the free-space optical communication apparatus in accordance with the first example embodiment of the present invention.

FIG. 3 is a block diagram illustrating an example of a schematic configuration of a free-space optical communication apparatus in accordance with a second example embodiment of the present invention.

FIG. 4 is a schematic diagram illustrating an example of a configuration of a light emission unit of the free-space optical communication apparatus in accordance with the second example embodiment of the present invention.

FIG. 5 is a schematic diagram illustrating an example of a configuration of a light reception unit of the free-space optical communication apparatus in accordance with the second example embodiment of the present invention.

FIG. 6 is a schematic diagram for describing an example of a schematic configuration of a free-space optical communication system in accordance with the second example embodiment of the present invention.

FIG. 7 is a flowchart illustrating an example of a link switching control in the free-space optical communication apparatus in accordance with the second example embodiment of the present invention.

FIG. 8 is a flowchart illustrating an example of a link switching control in the free-space optical communication apparatus in accordance with the second example embodiment of the present invention.

FIG. 9 is a schematic diagram for describing an example of signals transmitted via free-space optical communication links in accordance with the second example embodiment of the present invention.

FIG. 10 is a schematic diagram for describing another example of signals transmitted via free-space optical communication links in accordance with the second example embodiment of the present invention.

FIG. 11 is a schematic diagram for describing an example of communication control in the free-space optical communication apparatus in accordance with the second example embodiment of the present invention.

FIG. 12 is a schematic diagram for describing an example of optical axis alignment carried out by a free-space optical communication apparatus.

FIG. 13 is a schematic diagram for describing an example of optical axis alignment carried out by a free-space optical communication apparatus.

FIG. 14 is a schematic diagram for describing an example of a schematic configuration of a free-space optical communication system in accordance with a third example embodiment of the present invention.

FIG. 15 is a schematic diagram for describing an example of a schematic configuration of a free-space optical communication system in accordance with a fourth example embodiment of the present invention.

FIG. 16 is a schematic diagram illustrating an example of a configuration of a computer.

### EXAMPLE EMBODIMENTS

### First Example Embodiment

A first example embodiment of the present invention will be described in detail with reference to the drawings. The present example embodiment is an embodiment serving as a basis for example embodiments described later.

### (Configuration of Free-Space Optical Communication Apparatus)

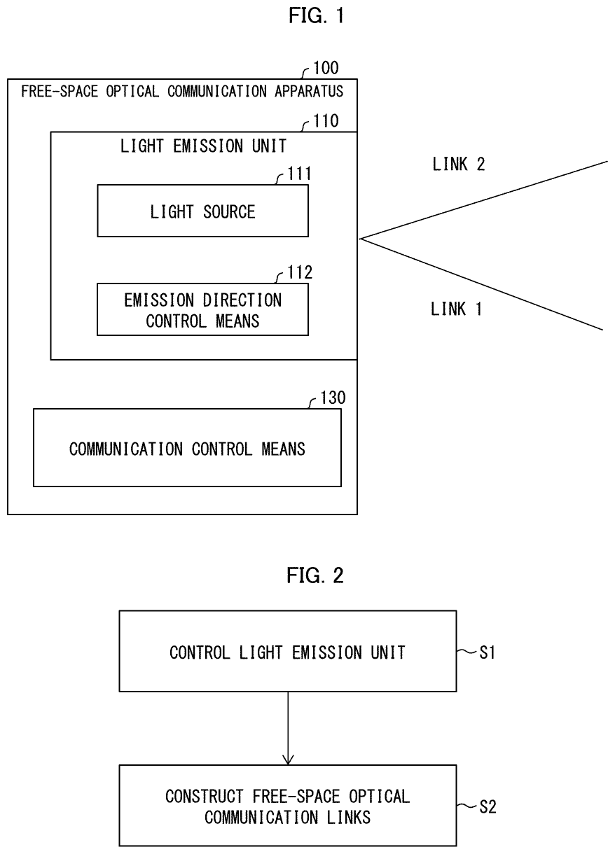

A configuration of a free-space optical communication apparatus 100 in accordance with the present example embodiment will be described with reference to FIG. 1. FIG. 1 is a block diagram illustrating the configuration of the free-space optical communication apparatus 100. The free-space optical communication apparatus 100 is a communication apparatus that carries out free-space optical communication. The free-space optical communication is communication that is carried out with use of light propagating through space. Examples of the light used in the free-space optical communication can include a millimeter wave, a submillimeter wave, infrared light, visible light, and ultraviolet light.

FIG. 1 illustrates a link 1 and a link 2 as free-space optical communication links that are constructed by the free-space optical communication apparatus 100. The present example embodiment, however, is not limited to this, and the free-space optical communication apparatus 100 can construct a plurality of free-space optical communication links. Note that constructing a free-space optical communication link means that free-space optical communication apparatuses are brought in a state (connection state) in which the free-space optical communication apparatuses can perform free-space optical communications with each other. Such a state encompasses both a state in which communication content is transmitted via the free-space optical communication link and a state in which the free-space optical communication link has merely been constructed without transmission of communication content via the free-space optical communication link. The free-space optical communication link can be in a state in which bidirectional communication is possible or in a state in which communication is possible in one direction.

The free-space optical communication apparatus 100 includes a light emission unit 110 that emits a laser beam and a communication control means 130 that controls the light emission unit 110. The communication control means 130 is an example of at least one processor. The light emission unit 110 includes a light source 111 and an emission direction control means 112 (emission direction control section).

The light source 111 outputs a single laser beam. The laser beam serves as communication light for free-space optical communication. The laser beam outputted from the light source 111 enters the emission direction control means 112.

The emission direction control means 112 controls an emission direction in which a laser beam is emitted from the light emission unit 110 after being outputted from the light source 111 in the form of the single laser beam. In the present specification, “controlling a direction in which a laser beam is emitted” encompasses controlling a direction in which at least part of a laser beam is emitted, and also encompasses causing part of a laser beam to be emitted in a direction different from a direction in which another part of the laser beam is emitted. In other words, the emission direction control means 112 is capable not only of controlling the direction of the entire laser beam but also of dividing the laser beam into a plurality of laser beams emitted in respective different emission directions.

In an example aspect, the emission direction control means 112 is realized by, for example, a ferroelectric liquid crystal, a homogeneous liquid crystal, a vertically aligned liquid crystal, or the like. Examples of the emission direction control means 112 include a liquid crystal on silicon (LCOS) device. The emission direction control means 112 has a plurality of light reception regions which the single laser beam outputted from the light source 111 enters, and is configured to cause Fraunhofer diffraction. The communication control means 130 can control the refractive index of each of the light reception regions by controlling a voltage applied to each of the light reception regions. Thus, the communication control means 130 can cause a difference in refractive index between the light reception regions to appropriately diffract the single laser beam which has entered the emission direction control means 112 from the light source 111. Thus, the emission direction control means 112 can control the direction of the laser beam outputted from the light source 111. In addition, the emission direction control means 112 can divide the laser beam outputted from the light source 111 into a plurality of laser beams and emit the laser beams in respective different emission directions. In another example aspect, the emission direction control means 112 can be realized by, for example, a large number of minute mirrors which can be individually controlled in inclination.

Apart from the above, the light emission unit 110 may include a lens, a filter, and the like.

The communication control means 130 controls the light emission unit 110 to construct a plurality of free-space optical communication links with use of laser beams. In an example aspect, the communication control means 130 may construct a plurality of free-space optical communication links by controlling the emission direction control means 112 to (i) divide a single laser beam outputted from the light source 111 into a plurality of laser beams and (ii) emit the plurality of laser beams respectively to a plurality of free-space optical communication apparatuses. In another example aspect, the communication control means 130 may construct a plurality of free-space optical communication links by controlling the emission direction control means 112 to emit a single laser beam, which has been outputted from the light source 111, respectively to a plurality of free-space optical communication apparatuses at respective different timings.

As described above, the free-space optical communication apparatus 100 in accordance with the present example embodiment can construct a plurality of free-space optical communication links with use of the light source 111 outputting a single laser beam and the emission direction control means 112 controlling an emission direction in which a laser beam is emitted from the light emission unit 110 after being outputted from the light source 111 in the form of the single laser beam. This provides an effect of making it possible to construct a plurality of free-space optical communication links with a compact configuration.

### (Flow of Method for Controlling Free-Space Optical Communication Apparatus)

A flow of a method for controlling a free-space optical communication apparatus in accordance with the present example embodiment will be described with reference to FIG. 2. In the method for controlling the free-space optical communication apparatus in accordance with the present example embodiment, a communication control process is carried out.

FIG. 2 is a flowchart illustrating an example of a communication control process carried out by the free-space optical communication apparatus 100. In step S1, the communication control means 130 controls the light emission unit 110 (the light source 111 and the emission direction control means 112). Then, in step S2, the communication control means 130 constructs a plurality of free-space optical communication links. In an example aspect, the communication control means 130 may construct a plurality of free-space optical communication links by controlling the emission direction control means 112 to (i) divide a single laser beam outputted from the light source 111 into a plurality of laser beams and (ii) emit the plurality of laser beams respectively to a plurality of free-space optical communication apparatuses. In another example aspect, the communication control means 130 may construct a plurality of free-space optical communication links by controlling the emission direction control means 112 to emit a single laser beam, which has been outputted from the light source 111, respectively to a plurality of free-space optical communication apparatuses at respective different timings.

As described above, the method for controlling the free-space optical communication apparatus in accordance with the present example embodiment can construct a plurality of free-space optical communication links with use of the light source 111 outputting a single laser beam and the emission direction control means 112 controlling an emission direction in which the laser beam is emitted. This provides an effect of making it possible to construct a plurality of free-space optical communication links with a compact configuration.

### Second Example Embodiment

The following will discuss in detail a second example embodiment of the present invention, with reference to drawings. Note that members having functions identical to those of the respective members described in the first example embodiment are given respective identical reference numerals, and a description of those members is omitted as appropriate.

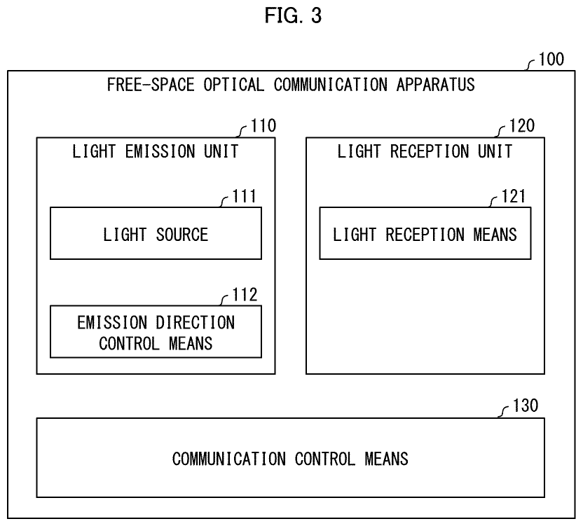

FIG. 3 is a block diagram illustrating a configuration of a free-space optical communication apparatus 100 in accordance with the present example embodiment. The free-space optical communication apparatus 100 includes a light emission unit 110, a light reception unit 120, and a communication control means 130. The light emission unit 110 includes a light source 111 and an emission direction control means 112. The light reception unit 120 includes a light reception means 121. The communication control means 130 controls the light emission unit 110 and the light reception unit 120.

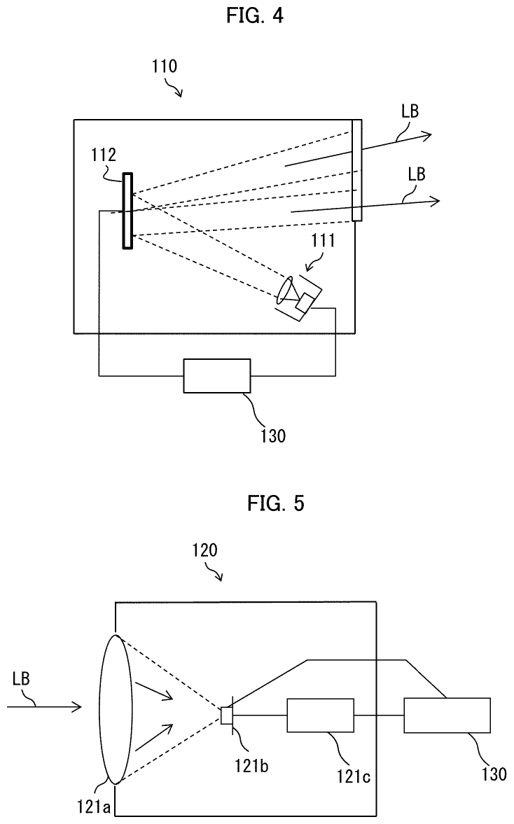

FIG. 4 is a schematic diagram illustrating an example of a configuration of the light emission unit 110. As illustrated in FIG. 4, a laser beam LB outputted from the light source 111 enters the emission direction control means 112 and is divided by the emission direction control means 112, and the laser beams LB thus divided are emitted from the light emission unit 110 in respective different emission directions. The light source 111 and the emission direction control means 112 are controlled by the communication control means 130. Note that the emission direction control means 112 may adjust the direction without dividing the laser beam LB.

FIG. 5 is a schematic diagram illustrating an example of a configuration of the light reception unit 120. As illustrated in FIG. 5, the light reception means 121 includes a condenser lens 121a, a light reception element 121b, and a reception circuit 121c. A laser beam LB from a destination of a free-space optical communication link is condensed by the condenser lens 121a and received by the light receiving element 121b. Then, the reception circuit 121c detects the laser beam LB received by the light reception element 121b. The detection result of the reception circuit 121c is provided to the communication control means 130.

### (Link Protection Using Free-Space Optical Communication Links)

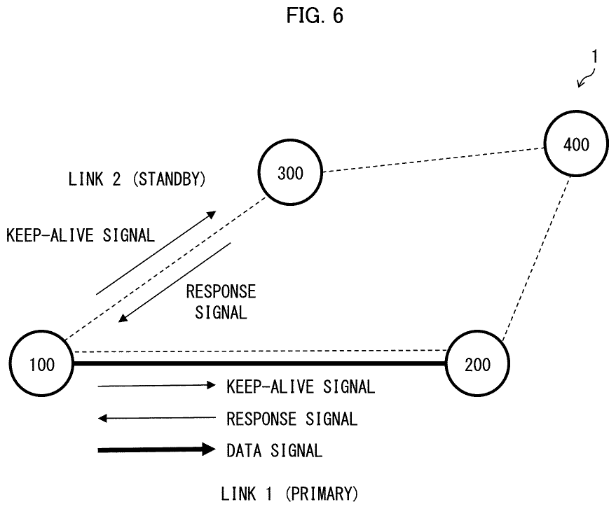

In the present example embodiment, a configuration in which so-called link protection is realized with use of a plurality of communication links will be described. FIG. 6 is a schematic diagram for describing an example of a schematic configuration of a free-space optical communication system 1 in accordance with the present example embodiment. The free-space optical communication system 1 includes a plurality of free-space optical communication apparatuses (100, 200, 300, 400). Note that the number of free-space optical communication apparatuses included in the free-space optical communication system 1 is not particularly limited, as long as the number is three or more. The following description will only discuss free-space optical communication links with which the free-space optical communication apparatus 100 is associated.

The free-space optical communication apparatus 100 has a link 1 constructed between the free-space optical communication apparatus 100 and the free-space optical communication apparatus 200, and has a link 2 constructed between the free-space optical communication apparatus 100 and the free-space optical communication apparatus 300. In the present example embodiment, the free-space optical communication apparatus 100 constructs the plurality of links 1 and 2 to thereby realize so-called link protection and achieve high reliability. Specifically, the link 1 is a primary link used for communication and the link 2 is a standby link used when the link 1 is cut off. A high reliability can be achieved by constructing the link 2. For example, the free-space optical communication apparatus 100 can transmit predetermined communication content to the free-space optical communication apparatus 400 via the link 2 even in a case where the link 1 is cut off.

On the link 1, which is a primary link, not only control signals (a keep-alive signal and a response signal responding thereto) for maintaining the free-space optical communication link are transmitted and received but also a data signal containing desired communication content is transmitted. On the link 2, which is a standby link, control signals (a keep-alive signal and a response signal responding thereto) for maintaining the free-space optical communication link are transmitted and received.

Control signals for maintaining a free-space optical communication link are signals transmitted and received in order to confirm a state in which the free-space optical communication link has been constructed (i.e., a state in which it is possible to perform communications via the free-space optical communication link), and are constituted by a keep-alive signal (link retaining signal) and a response signal responding thereto. Specifically, a keep-alive signal is transmitted from one of the free-space optical communication apparatuses constituting a free-space optical communication link to the other of the free-space optical communication apparatuses, and a response signal is transmitted from the other of the free-space optical communication apparatuses to the one of the free-space optical communication apparatuses, so that both of these free-space optical communication apparatuses are able to recognize that the free-space optical communication link has been constructed. Note that the response signal can be transmitted and received via another communication path without passing through the free-space optical communication link. The transmission timing of the keep-alive signal is not particularly limited. For example, the keep-alive signal may be transmitted in a predetermined cycle.

The communication control means 130 of the free-space optical communication apparatus 100 controls the light emission unit 110 to transmit communication content via at least one free-space optical communication link (in the example illustrated in FIG. 6, the link 1) among the plurality of free-space optical communication links (in the example illustrated in FIG. 6, the link 1 and the link 2) and transmit, via another free-space optical communication link (in the example illustrated in FIG. 6, the link 2) among the plurality of free-space optical communication links, a control signal for maintaining the another free-space optical communication link. The communication control means 130 of the free-space optical communication apparatus 100 can control the light emission unit 110 to transmit, via the above-described at least one free-space optical communication link (in the example illustrated in FIG. 6, the link 1), a control signal for maintaining the at least one free-space optical communication link. This enables the free-space optical communication apparatus 100 to construct a plurality of free-space optical communication links for realizing link protection.

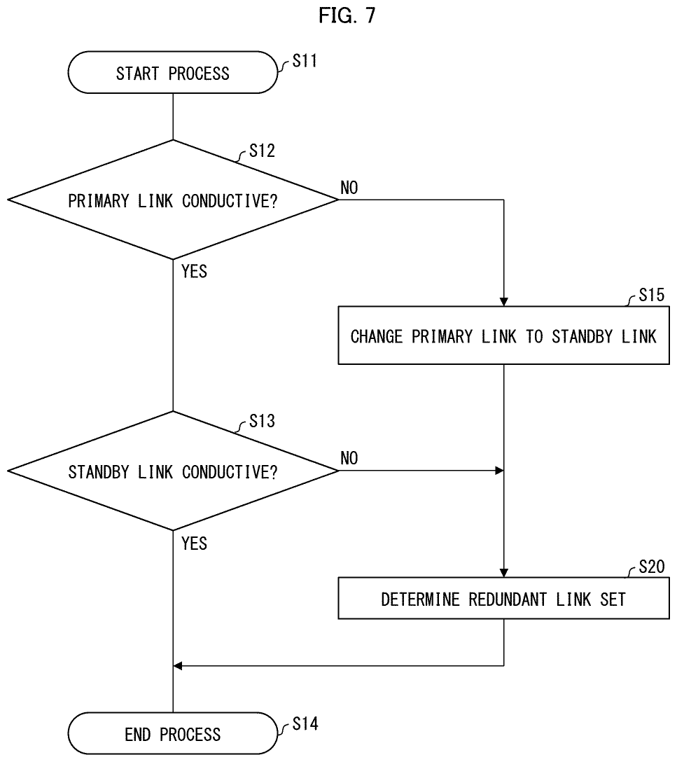

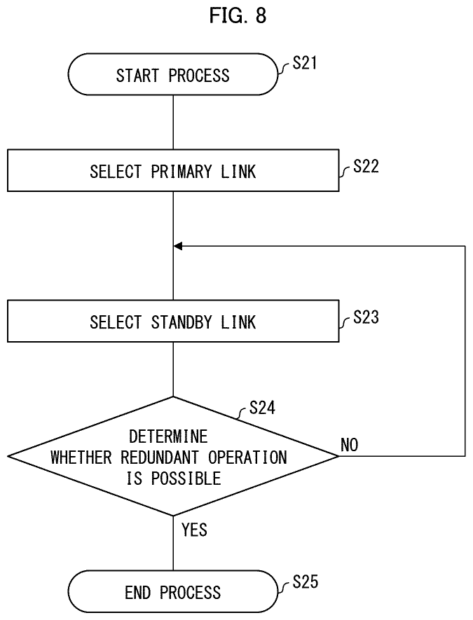

Further, the communication control means 130 controls the light emission unit 110 to transmit, in a case where at least one free-space optical communication link is cut off, communication content via another free-space optical communication link. FIGS. 7 and 8 are flowcharts each illustrating an example of a link switching control carried out by the free-space optical communication apparatus 100. For example, at a timing at which new communication is started, at a given timing during communication, at a timing at which communication is stopped, or the like timings, the process is started (step S11).

The communication control means 130 determines whether or not the primary link (in the example illustrated in FIG. 6, the link 1) is conductive (a state in which the primary link has been constructed) (step S12). The determination can be made on the basis of, for example, whether or not a data signal has successfully been transmitted via the primary link, or whether or not a response signal in response to transmission of a keep-alive signal via the primary link has successfully been received.

In a case where the primary link is conductive (Yes in step S12), the communication control means 130 determines whether or not the standby link (in the example illustrated in FIG. 6, the link 2) is conductive (a state in which the standby link has been constructed) (step S13). The determination can be made on the basis of, for example, whether or not a response signal in response to transmission of a keep-alive signal via the standby link has successfully been received. In a case where the standby link is conductive (Yes in step S13), the process is completed (step S14).

In a case where the primary link is not conductive (No in step S12), the communication control means 130 changes the primary link to a standby link (step S15) and carries out a process of determining a redundant link set (step S20). Further, in a case where the standby link is not conductive (No in step S13), the communication control means 130 carries out the process of determining a redundant link set (step S20).

Step S20 includes steps S21 to S25. When the process of determining a redundant link set is started (step S21), the communication control means 130 selects a primary link from among a plurality of free-space optical communication links that have been constructed (step S22), and selects a standby link from among free-space optical communication links other than the primary link that has been selected (step S23).

Then, the communication control means 130 determines whether or not it is possible to carry out communication with use of the primary link and the standby link which have been selected (step S24). In a case where it is possible to carry out communication with use of the primary link and the standby link which have been selected (Yes in step S24), the process of determining a redundant link set is ended (step S25). In a case where it is not possible to carry out communication with use of the primary link and the standby link which have been selected (No in step S24), the process returns to step S23 in which a standby link is reselected. Note that, at this time, the process may return to step S22 to reselect a primary link.

(Method of Division into Free-Space Optical Communication Links)

In an example aspect, the free-space optical communication apparatus 100 can use space division to achieve the construction of a plurality of free-space optical communication links. That is, the communication control means 130 can construct free-space optical communication links with a plurality of free-space optical communication apparatuses by controlling the light emission unit 110 to divide a single laser beam into a plurality of laser beams which are in respective different emission directions.

For example, the communication control means 130 causes the light source 111 to output a single laser beam which is as follows: a portion of the single laser beam which portion enters a first light reception region of the emission direction control means 112 has superimposed thereon communication content to be communicated with the link 1, and a portion of the single laser beam which portion enters a second light reception region of the emission direction control means 112 has superimposed thereon communication content to be communicated with the link 2. Then, the communication control means 130 causes the emission direction control means 112 to divide the single laser beam so that (i) the portion of the laser beam which portion has entered the first light reception region is used as a laser beam emitted to the link 1, and (ii) the portion of the laser beam which portion has entered the second light reception region is used as a laser beam emitted to the link 2. Thus, space division can be achieved.

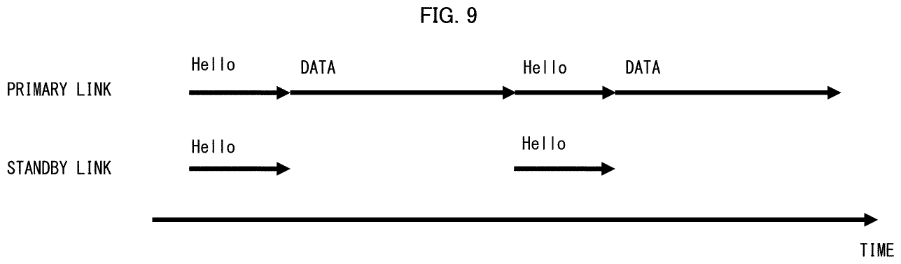

FIG. 9 is a schematic diagram illustrating an example of signals transmitted via a plurality of free-space optical communication links constructed by space division. As illustrated in FIG. 9, in a predetermined cycle, keep-alive signals (“Hello” in FIG. 9) are transmitted respectively on the primary link and the standby link, and a data signal is transmitted on the primary link so as not to overlap with the keep-alive signals.

In another example aspect, the free-space optical communication apparatus 100 can use time division to achieve the construction of a plurality of free-space optical communication links. That is, the communication control means 130 can construct free-space optical communication links with a plurality of free-space optical communication apparatuses by controlling the light emission unit 110 to emit a single laser beam in a plurality of emission directions at respective different timings.

For example, the communication control means 130 causes the light source 111 to output a single laser beam which is as follows: the single laser beam has superimposed thereon, in a first period, communication content to be communicated with the link 1, and has superimposed thereon, in a second period different from the first period, communication content to be communicated with the link 2. Then, the communication control means 130 causes the emission direction control means 112 to emit the single laser beam to the link 1 in the first period and to the link 2 in the second period. Thus, time division (space and time divisions) can be achieved.

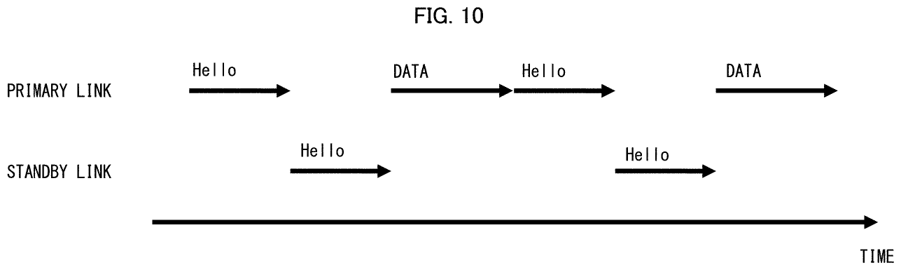

FIG. 10 is a schematic diagram illustrating an example of signals transmitted via a plurality of free-space optical communication links constructed by time division. As illustrated in FIG. 10, in a predetermined cycle, a keep-alive signal is transmitted on the primary link, a keep-alive signal is transmitted on the standby link so as not to overlap with the keep-alive signal on the primary link, and a data signal is transmitted on the primary link so as not to overlap with any of these keep-alive signals.

Note that laser beams respectively transmitted via the link 1 and the link 2 may be the same as or different from each other in frequency.

In an example aspect, the communication control means (acquisition means) 130 of the free-space optical communication apparatus 100 can acquire, via free-space optical communication links (in the example illustrated in FIG. 6, the link 1 and the link 2), received powers of laser beams at free-space optical communication apparatuses (in the example illustrated in FIG. 6, the free-space optical communication apparatus 200 and the free-space optical communication apparatus 300) which receive the respective laser beams emitted from the free-space optical communication apparatus 100. The received powers at the respective free-space optical communication apparatuses may be acquired by the communication control means 130 via the free-space optical communication links or via another communication means (not illustrated).

In a case where the above-described space division, the communication control means 130 can adjust at least one selected from the group consisting of following (i) and (ii) so that each of the acquired received powers at the respective free-space optical communication apparatuses exceeds a set value: (i) a ratio in which a single laser beam outputted from the light source 111 is divided into a plurality of laser beams and (ii) output of the light source 111.

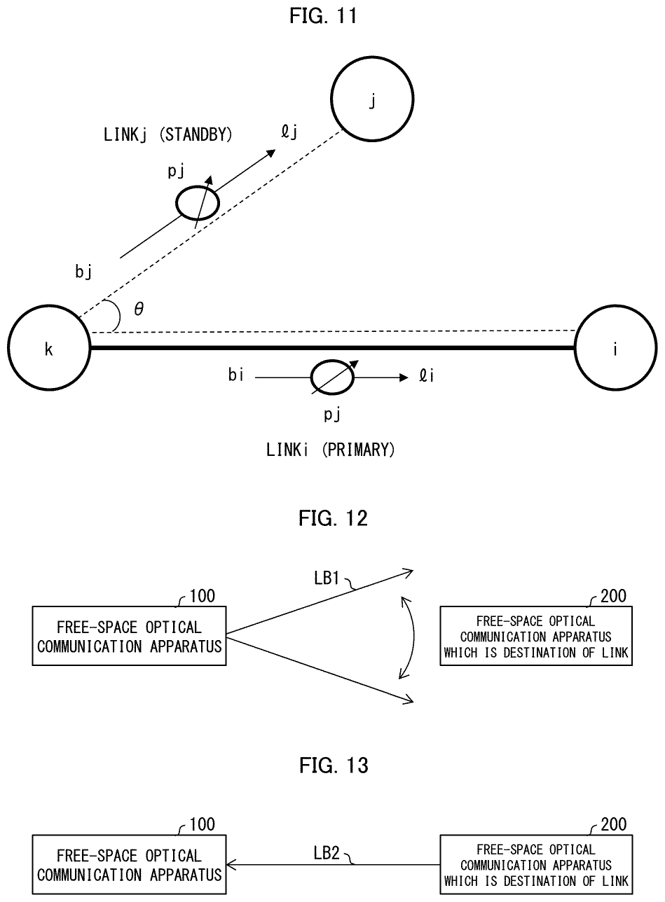

FIG. 11 is a schematic diagram illustrating a free-space optical communication apparatus k that has a link i constructed between the free-space optical communication apparatus k and a free-space optical communication apparatus i and has a link j constructed between the free-space optical communication apparatus k and a free-space optical communication apparatus j, the link i and the link j serving as a primary link and a standby link, respectively.

The transmission power of a laser beam emitted from the free-space optical communication apparatus k to the link i is denoted as bi, and the received power of the laser beam received by the free-space optical communication apparatus i is denoted as li. The transmission power of a laser beam emitted from the free-space optical communication apparatus k to the link j is denoted as bj, and the received power of the laser beam received by the free-space optical communication apparatus j is denoted as lj. A path loss (loss of a laser beam which may occur in a path between free-space optical communication apparatuses) on the link i is denoted as pi, and a path loss on the link j is denoted as pj.

In this case, bi, li, and pi are in a relationship of li=bi−pi. Further, bj, lj, and pj are in a relationship of lj=bj−pj. In a case where a set value which is set as the minimum light reception power at which the laser beam can be effectively received is 1 min, li>1 min and lj>1 min must be satisfied. The communication control means 130 adjusts bi and bj so as to satisfy such expressions. bi and bj are determined by (i) a ratio in which a single laser beam emitted by the light source 111 is divided into a plurality of laser beams and (ii) output of the light source 111. As such, the communication control means 130 may adjust at least one selected from the group consisting of the division ratio and the output.

In FIG. 11, an angle formed by a straight line representing a laser beam constituting the link i, which serves as a primary link, and a straight line representing a laser beam constituting the link j, which serves as a standby link, is denoted as 0. The laser beam constituting the link j is emitted in a direction inclined by an angle θ with respect to the laser beam constituting the link i. As such, the laser beam constituting the link j has a light transmission power decreased by s(θ), which is a function of θ, in comparison with the laser beam constituting the link i. This s(θ) will be referred to as a beam steer loss function. In this case, a relationship of lj=bjxs(θ)−pj is established.

The above s(θ) can be approximated as cos(θ) when 0 is small. As such, the relationship of lj=bj×s(θ)−pj means that the light transmission power decreases as the angle of the laser beam constituting the link j with respect to the laser beam constituting the link i increases.

Thus, there are two methods of searching for a link j serving as a standby link after determining a link i serving as a primary link: one is searching for j that reduces θ and the other is searching for j that increases θ. The former has an advantage that beam loss can be reduced. The latter has an advantage that, when carrying out space division communications, a link j serving as a standby link is easily distinguished from a link i serving as a primary link. Examples of a search method used when carrying out space division communications include a method of first carrying out a search by the former method and then switching to the latter method in a case where it is difficult to find a standby link.

### (Optical Axis Alignment)

In an example aspect, construction of a free-space optical communication link includes optical axis alignment with a free-space optical communication apparatus which is a destination of the free-space optical communication link. The optical axis alignment refers to, at least, aligning the optical axis of the light emission unit of one free-space optical communication apparatus with the optical axis of the light reception unit of the other free-space optical communication apparatus, and can further include aligning the optical axis of the light reception unit of the free-space optical communication apparatus with the optical axis of the light emission unit of the other free-space optical communication apparatus.

FIGS. 12 and 13 are each a schematic diagram for describing an example of optical axis alignment carried out by a free-space optical communication apparatus. The following description will discuss, as an example, a process flow in which the free-space optical communication apparatus 100 carries out scanning to carry out optical axis alignment with the free-space optical communication apparatus 200 which is a destination of a free-space optical communication link. The optical axis alignment between any free-space optical communication apparatuses can also be carried out in a similar fashion. Note that “scanning” may be restated as “search”. Further, the optical axis alignment of the free-space optical communication apparatus 100 is controlled by the communication control means 130.

The communication control means 130 causes the light source 111 to output a laser beam LB1 for optical axis alignment and causes the emission direction control means 112 to change a light emission direction of the laser beam LB1 (scanning). Then, the laser beam LB1 emitted from the free-space optical communication apparatus 100 in a correct direction is received by the free-space optical communication apparatus 200.

The laser beam LB1 has superimposed thereon (i) identification information that identifies the free-space optical communication apparatus 100 and (ii) direction information (azimuth angle, elevation angle, and depression angle) that indicates the direction in which the laser beam LB1 has been emitted.

In a case where the free-space optical communication apparatus 200 successfully receives the laser beam LB1, that is, the optical axes of the free-space optical communication apparatuses 100 and 200 coincide with each other, the free-space optical communication apparatus 200 acquires the identification information and the direction information that are contained in the laser beam LB1 and identifies the direction of the free-space optical communication apparatus 100. Further, the free-space optical communication apparatus 200 may identify a distance to the free-space optical communication apparatus 100 in accordance with attenuation of the laser beam LB1. This enables the free-space optical communication apparatus 200 to identify a relative position of the free-space optical communication apparatus 100.

As illustrated in FIG. 13, the free-space optical communication apparatus 200 emits, toward the free-space optical communication apparatus 100, a laser beam LB2 for optical axis alignment. The laser beam LB2 contains identification information that identifies the free-space optical communication apparatus 200; direction information acquired from the laser beam LB1; and distance information that indicates a distance to the free-space optical communication apparatus 100, which distance has been identified by the free-space optical communication apparatus 200. When the light reception means 121 receives the laser beam LB2, the communication control means 130 can acquire the identification information, the direction information, and the distance information contained in the laser beam LB2, identify the direction of the free-space optical communication apparatus 200 and the distance to the free-space optical communication apparatus 200, and identify a relative position of the free-space optical communication apparatus 200. Thus, the optical axis alignment is completed.

This enables the communication control means 130 to detect an emission direction in which it is possible to carry out free-space optical communications with the free-space optical communication apparatus 200 (destination of a free-space optical communication link). Thus, the communication control means 130 becomes able to emit a laser beam toward the destination of the free-space optical communication link.

### Third Example Embodiment

The following will discuss in detail a third example embodiment of the present invention, with reference to drawings. Note that constitutional elements having the same functions as those of the constitutional elements described in the first or second example embodiment are denoted by the same reference signs, and descriptions thereof will be omitted as appropriate.

### (Link Redundancy Using Free-Space Optical Communication Links)

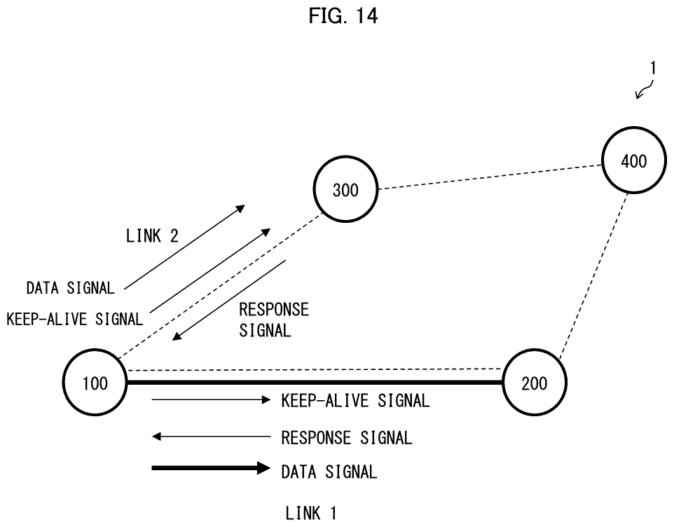

In the present example embodiment, a configuration that realizes so-called link redundancy with use of a plurality of communication links will be described. FIG. 14 is a schematic diagram for describing an example of a schematic configuration of a free-space optical communication system 1 in accordance with the present example embodiment.

A free-space optical communication apparatus 100 has a link 1 constructed between the free-space optical communication apparatus 100 and a free-space optical communication apparatus 200, and has a link 2 constructed between the free-space optical communication apparatus 100 and a free-space optical communication apparatus 300. In the present example embodiment, the free-space optical communication apparatus 100 constructs the plurality of links 1 and 2, and the communication control means 130 causes the same communication content to be transmitted via the plurality of free-space optical communication links. This allows the free-space optical communication apparatus 100 to realize so-called link redundancy and achieve high reliability. That is, by causing the same communication content to be transmitted via the link 1 and the link 2, the communication can be continued even if either one of the link 1 and the link 2 is cut off.

On each of the link 1 and the link 2, not only control signals (a keep-alive signal and a response signal responding thereto) for maintaining the free-space optical communication link are transmitted and received but also a data signal containing desired communication content is transmitted.

### Fourth Example Embodiment

The following will discuss in detail a fourth example embodiment of the present invention, with reference to drawings. Note that constitutional elements having the same functions as those of the constitutional elements described in the first or second example embodiment are denoted by the same reference signs, and descriptions thereof will be omitted as appropriate.

### (Link Aggregation Using Free-Space Optical Communication Links)

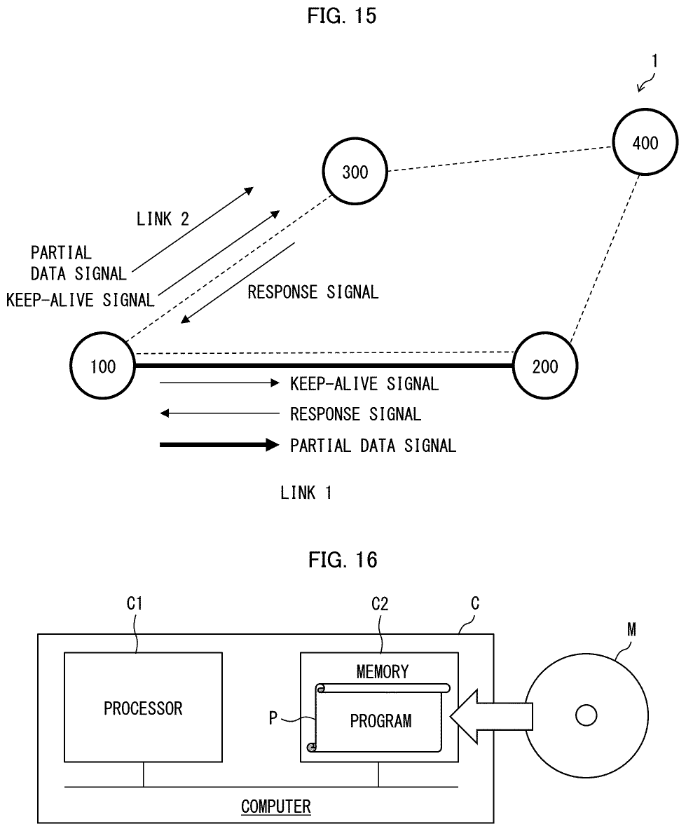

In the present example embodiment, a configuration in which so-called link aggregation is realized with use of a plurality of communication links will be described. FIG. 15 is a schematic diagram for describing an example of a schematic configuration of a free-space optical communication system 1 in accordance with the present example embodiment.

A free-space optical communication apparatus 100 has a link 1 constructed between the free-space optical communication apparatus 100 and a free-space optical communication apparatus 200, and has a link 2 constructed between the free-space optical communication apparatus 100 and a free-space optical communication apparatus 300. In the present example embodiment, the free-space optical communication apparatus 100 constructs the plurality of links 1 and 2, and the communication control means 130 causes communication content portions, into which one communication content is divided, to be transmitted via the respective plurality of free-space optical communication links. This allows the free-space optical communication apparatus 100 to realize so-called link aggregation and achieve high throughput. That is, communication content portions (partial data signals) into which one communication content is divided are sent via the link 1 and the link 2, respectively, and the communication content portions are combined together, for example, at a free-space optical communication apparatus 400. This makes it possible to improve throughput between the free-space optical communication apparatus 100 and the free-space optical communication apparatus 400.

### [Software Implementation Example]

Some or all of functions of the free-space optical communication apparatus 100 can be realized by hardware such as an integrated circuit (IC chip) or can be alternatively realized by software.

In the latter case, the free-space optical communication apparatus 100 is realized by, for example, a computer that executes instructions of a program that is software realizing the foregoing functions. FIG. 16 illustrates an example of such a computer (hereinafter referred to as a “computer C”). The computer C includes at least one processor C1 and at least one memory C2. The at least one memory C2 stores a program P for causing the computer C to operate as the free-space optical communication apparatus 100. In the computer C, the processor C1 reads the program P from the memory C2 and executes the program P, so that the functions of the free-space optical communication apparatus 100 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display, and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following example aspects.

### (Supplementary Note 1)

A free-space optical communication apparatus, including:
a light emission unit; and
a communication control means,
the light emission unit including
   (i) a light source that outputs a single laser beam and
   (ii) an emission direction control means that controls an emission direction in which a laser beam is emitted from the light emission unit after being outputted from the light source in the form of the single laser beam,
the communication control means controlling the light emission unit to construct a plurality of free-space optical communication links with use of the laser beam.

### (Supplementary Note 2)

The free-space optical communication apparatus according to supplementary note 1, wherein the communication control means controls the light emission unit to divide the single laser beam into a plurality of laser beams which are in respective different emission directions.

### (Supplementary Note 3)

The free-space optical communication apparatus according to supplementary note 2, further including an acquisition means that acquires respective received powers of the plurality of laser beams at free-space optical communication apparatuses, the free-space optical communication apparatuses respectively receiving the plurality of laser beams via the plurality of free-space optical communication links; and
the communication control means adjusts at least one selected from the group consisting of the following (i) and (ii) so that each of the received powers exceeds a set value: (i) a ratio in which the single laser beam is divided into the plurality of laser beams; and (ii) output of the light source.

### (Supplementary Note 4)

The free-space optical communication apparatus according to supplementary note 1, wherein the communication control means controls the light emission unit to emit the single laser beam in a plurality of emission directions at respective different timings.

### (Supplementary Note 5)

The free-space optical communication apparatus according to any one of supplementary notes 1 to 4, wherein the communication control means controls the light emission unit to transmit communication content via at least one free-space optical communication link among the plurality of free-space optical communication links and transmit, via another free-space optical communication link among the plurality of free-space optical communication links, a control signal for maintaining the another free-space optical communication link.

### (Supplementary Note 6)

The free-space optical communication apparatus according to supplementary note 5, wherein the communication control means controls the light emission unit to transmit the communication content via the another free-space optical communication link in a case where the at least one free-space optical communication link is cut off.

### (Supplementary Note 7)

The free-space optical communication apparatus according to any one of supplementary notes 1 to 4, wherein the communication control means causes the same communication content to be transmitted via the plurality of free-space optical communication links.

### (Supplementary Note 8)

The free-space optical communication apparatus according to any one of supplementary notes 1 to 4, wherein the communication control means controls the light emission unit to transmit communication content portions, into which one communication content is divided, respectively via the plurality of free-space optical communication links.

### (Supplementary Note 9)

A free-space optical communication system, including not less than three of the free-space optical communication apparatus according to any one of supplementary notes 1 to 8.

### (Supplementary Note 10)

A method for controlling a free-space optical communication apparatus including a light emission unit,
the light emission unit including:
   a light source that outputs a single laser beam; and
   an emission direction control means that controls an emission direction in which the single laser beam outputted from the light source is emitted,
the method including a communication control process of controlling the light emission unit to construct a plurality of free-space optical communication links each of which is constructed with use of the single laser beam.

### (Supplementary Note 11)

A free-space optical communication apparatus, including:
a light emission unit; and
at least one processor,
the light emission unit including
   (i) a light source that outputs a single laser beam and
   (ii) an emission direction control means that controls an emission direction in which a laser beam is emitted from the light emission unit after being outputted from the light source in the form of the single laser beam,
the at least one processor carrying out a communication control process of controlling the light emission unit to construct a plurality of free-space optical communication links with use of the laser beam.

Note that the free-space optical communication apparatus can further include a memory. The memory can store a program for causing the at least one processor to carry out the communication control process. The program can be stored in a computer-readable non-transitory tangible storage medium.

### REFERENCE SIGNS LIST

100, 200, 300, 400: free-space optical communication apparatus
110: light emission unit
111: light source
112: emission direction control means
130: communication control means

1. A free-space optical communication apparatus, comprising:
a light emission unit; and
at least one processor,
the light emission unit including
(i) a light source that outputs a single laser beam and
(ii) an emission direction control section that controls an emission direction in which a laser beam is emitted from the light emission unit after being outputted from the light source in the form of the single laser beam,
the at least one processor carrying out a communication control process of controlling the light emission unit to construct a plurality of free-space optical communication links with use of the laser beam.

2. The free-space optical communication apparatus according to claim 1, wherein
in the communication control process, the at least one processor controls the light emission unit to divide the single laser beam into a plurality of laser beams which are in respective different emission directions.

3. The free-space optical communication apparatus according to claim 2, wherein:
the at least one processor further carries out an acquisition process of acquiring respective received powers of the plurality of laser beams at free-space optical communication apparatuses, the free-space optical communication apparatuses respectively receiving the plurality of laser beams via the plurality of free-space optical communication links; and
in the communication control process, the at least one processor adjusts at least one selected from the group consisting of the following (i) and (ii) so that each of the received powers exceeds a set value: (i) a ratio in which the single laser beam is divided into the plurality of laser beams; and (ii) output of the light source.

4. The free-space optical communication apparatus according to claim 1, wherein
in the communication control process, the at least one processor controls the light emission unit to emit the single laser beam in a plurality of emission directions at respective different timings.

5. The free-space optical communication apparatus according to claim 1, wherein
in the communication control process, the at least one processor controls the light emission unit to transmit communication content via at least one free-space optical communication link among the plurality of free-space optical communication links and transmit, via another free-space optical communication link among the plurality of free-space optical communication links, a control signal for maintaining the another free-space optical communication link.

6. The free-space optical communication apparatus according to claim 5, wherein
in the communication control process, the at least one processor controls the light emission unit to transmit the communication content via the another free-space optical communication link in a case where the at least one free-space optical communication link is cut off.

7. The free-space optical communication apparatus according to claim 1, wherein
in the communication control process, the at least one processor causes the same communication content to be transmitted via the plurality of free-space optical communication links.

8. The free-space optical communication apparatus according to claim 1, wherein
in the communication control process, the at least one processor controls the light emission unit to transmit communication content portions, into which one communication content is divided, respectively via the plurality of free-space optical communication links.

9. A free-space optical communication system, comprising not less than three of the free-space optical communication apparatus according to claim 1.

10. A method for controlling a free-space optical communication apparatus including a light emission unit,
the light emission unit including:
a light source that outputs a single laser beam; and
an emission direction control section that controls an emission direction in which a laser beam is emitted from the light emission unit after being outputted from the light source in the form of the single laser beam,
the method comprising a communication control process of controlling the light emission unit to construct a plurality of free-space optical communication links with use of the laser beam, the communication control process being carried out by the at least one processor of the free-space optical communication apparatus.

11. The method according to claim 10, wherein in the communication control process, the at least one processor controls the light emission unit to divide the single laser beam into a plurality of laser beams which are in respective different emission directions.

12. The method according to claim 11, further comprising an acquisition process of acquiring respective received powers of the plurality of laser beams at free-space optical communication apparatuses, the free-space optical communication apparatuses respectively receiving the plurality of laser beams via the plurality of free-space optical communication links, the acquisition process being carried out by the at least one processor,
in the communication control process, the at least one processor adjusting at least one selected from the group consisting of the following (i) and (ii) so that each of the received powers exceeds a set value: (i) a ratio in which the single laser beam is divided into the plurality of laser beams; and (ii) output of the light source.

13. The method according to claim 10, wherein in the communication control process, the at least one processor controls the light emission unit to emit the single laser beam in a plurality of emission directions at respective different timings.

14. The method according to claim 10, wherein in the communication control process, the at least one processor controls the light emission unit to transmit communication content via at least one free-space optical communication link among the plurality of free-space optical communication links and transmit, via another free-space optical communication link among the plurality of free-space optical communication links, a control signal for maintaining the another free-space optical communication link.

15. The method according to claim 14, wherein in the communication control process, the at least one processor controls the light emission unit to transmit the communication content via the another free-space optical communication link in a case where the at least one free-space optical communication link is cut off.

16. The method according to claim 10, wherein in the communication control process, the at least one processor causes the same communication content to be transmitted via the plurality of free-space optical communication links.

17. The method according to claim 10, wherein in the communication control process, the at least one processor controls the light emission unit to transmit communication content portions, into which one communication content is divided, respectively via the plurality of free-space optical communication links.
